(19) United States
(12) Patent Application Publication
(10) Pub. No.: US 2007/0214287 A1
(43) Pub. Date: Sep. 13, 2007

(54) Information playback apparatus

(76) Inventors: Kosuke Haruki, Ome-shi (JP); Masahiko Mawatari, Yokohama-shi (JP); Tatsuyuki Matsushita, Kawasaki-shi (JP); Tooru Kamibayashi, Chigasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/716,091

(22) Filed: Mar. 9, 2007

(30) Foreign Application Priority Data
Mar. 9, 2006 (JP) 2006-064601

(51) Int. Cl. G06F 3/00

(52) U.S. Cl. 710/1

(57) ABSTRACT

According to one embodiment, since key information is written after a drive unit and host unit are assembled into a player, it is not necessary to manage, in the assembled player, the correspondence in secret key information between the drive unit and host unit. Further, in the player, even if, for example, the drive unit must be exchanged for another, encrypted key data can be shared simply by writing another key data item.

### CROSS-REFERENCE TO RELATED APPLICATIONS

This application is based upon and claims the benefit of priority from Japanese Patent Application No. 2006-064601, filed Mar. 9, 2006, the entire contents of which are incorporated herein by reference.

### BACKGROUND

1. Field

One embodiment of the invention relates to a function of enabling a value shared, for communication requiring authentication, between a drive unit and host device connected to each other via, for example, IDE/ATAPI to be written in a secured manner, even in a state in which the drive unit and host device are connected to each other.

2. Description of the Related Art

When generating a key shared for authentication between two objects, e.g., a host device and a drive unit incorporated therein, it is necessary to share a secret value between the objects.

For instance, when authentication is performed in a DVD player provided with a hard disk drive as a memory device and connected to each other via, for example, integrated device electronics (IDE)/attachment packet interface (ATAPI), it is necessary to hold a shared secret value (for generating a shared key) between the player (host device, i.e., the entire reading device incorporating the drive unit) and hard disk drive (drive unit). For the purpose of security, different shared secret keys are needed for different devices. IDE is an interface for connecting a personal computer to a hard disk contained therein. ATAPI is a specification acquired by standardizing the enhanced IDE interface in the American National Standards Institute (ANSI), and means, in particular, an interface, such as a CD-ROM drive or DVD drive, used to connect an auxiliary memory device other than hard disks (to control the speed of data transfer).

For example, Japanese Patent Application Publication (KOKAI) No. 2005-020759 discloses an authentication method for use in a data processing device including a writing unit, in which when the data processing device (host unit) is connected for the first time to the writing unit (HDD), a shared secret key is assigned to both units to enable subsequent interactive authentication.

Apart from the above, the manufacturers (sources) of drive units may well differ from those of host units. If shared secret values shared between respective combinations of drive units and host units are written in different manufacturing places, manufacturing/management may well be complex.

Further, if a shared secret value is of specifications that enable anyone to write it easily, the authentication flow may be weakened. Therefore, it is also necessary to manage the writing flow itself secretly.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information playback apparatus according to an embodiment of the invention;

FIGS. 2A and 2B are exemplary diagrams explaining supply of a shared key in the information playback apparatus of FIG. 1 that incorporates a host unit (player) and disk read unit (drive unit) according to an embodiment of the invention;

FIG. 3 is an exemplary diagram explaining another way of supply of the shared key in the information playback apparatus shown in FIGS. 2A and 2B according to an embodiment of the invention;

FIG. 4 is an exemplary diagram explaining a timing example of key supply and a supply method example employed in FIGS. 2A and 2B according to an embodiment of the invention;

FIG. 5 is an exemplary diagram explaining another timing example of key supply and another supply method example, employed in FIGS. 2A and 2B according to an embodiment of the invention; and

FIG. 6 is an exemplary diagram explaining still another timing example of key supply and yet another supply method example, employed in FIGS. 2A and 2B according to an embodiment of the invention.

### DETAILED DESCRIPTION

Various embodiments according to the invention will be described hereinafter with reference to the accompanying drawings. In general, according to one embodiment of the invention, an information playback apparatus comprising: a disk drive unit configured to read information from a disk-shaped recording medium; an information playback main unit holding the disk drive unit and configured to supply a display unit with an output of the disk drive unit in a state in which the output is permitted to be displayed on the display unit; and an interface holding shared key information shared between the disk drive unit and the information playback main unit, the interface being configured at least to supply the shared key information to the information playback main unit, and to transfer the shared key information from the information playback main unit to the disk drive unit.

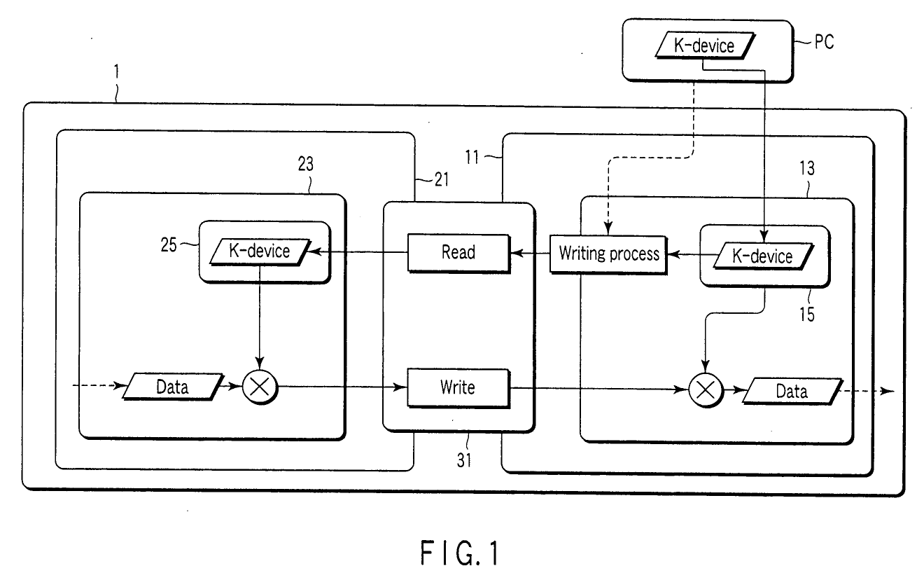

According to an embodiment, FIG. 1 shows an example of an information playback apparatus (an optical disc apparatus), i.e., a disk player, according to an embodiment of the invention.

In general, when a drive and host connected to each other via, for example, IDE/ATAPI perform communication that requires authentication, it is necessary to secure a shared value.

The information playback apparatus of FIG. 1 has a function of writing shared values in a secured manner for performing communication required authentication, even after a plurality of drives and a host incorporated therein are connected. Specifically, by virtue of this function, shared encryption key data or original data that can be converted into shared encryption key data, used to encrypt data transferred between a DVD drive unit and host unit connected via a versatile interface, can be written to the DVD drive unit after the two units are connected to each other.

FIG. 1 shows an example of an information playback apparatus, i.e., disk-reading device (hereinafter referred to as a player) 1 capable of reading content, such as a program or data, from, for example, a DVD disk when the DVD disk is set in the device. Specifically, FIG. 1 schematically shows a state in which a host unit (player main unit, i.e., the essential part of the player 1) 11 and DVD drive unit 21 are connected via an attachment packet interface (ATAPI) bus 31.

The host unit 11 includes an encryption section 13 that can write a secret shared value (a secret value shared between the drive unit 21 and host unit 11, which will hereinafter be referred to as a key [K-device]) unique to the host unit 11 and capable of maintaining security when the host unit 11 is connected to the drive unit 21. The host unit 11 further comprises a nonvolatile memory (hereinafter simply referred to as the NVM) 15 for holding the key [K-device].

The drive unit 21 comprises an encryption section 23 capable of maintaining security and receiving the key [K-device] from the host unit 11 when it is set in (connected to) the host unit 11, and a nonvolatile memory (hereinafter simply referred to as the NVM) 25 for holding the key [K-device].

The ATAPI bus 31 is a versatile bus, and certain encryption is necessary to transmit/receive data in a secured manner via the ATAPI bus 31. Therefore, the externally input key [K-device] is written to the NVMs 15 and 25 via the encryption sections 13 and 23, respectively, after the host unit 11 and drive unit 21 are connected to each other. Namely, the shared key [K-device] is held in the NVMs 15 and 25 of the host unit 11 and drive unit 21, respectively.

Further, the key [K-device] is shared by the host unit 11 and drive unit 21, and has values unique to respective combinations (sets) of drive units and host units. To this end, respective independent keys are beforehand assigned to the drive unit 21 and host unit 11 to encrypt the shared key [K-device] therein. The thus-encrypted keys are held in the NVMs 15 and 25.

The key [K-device] is supplied by, for example, a personal computer PC (used in the manufacturing [assembling] line of the host unit 11, i.e., used by a assembling maker). Therefore, it is assumed that a unique command is defined, instead of a versatile command, and used on only the manufacturing line, when writing the key [K-device] is written to the drive unit 21.

More specifically, when an arbitrary number of drive units [21A], [21B], . . . [21-N] (for facilitating the description, the individual drive units will be thus discriminated by alphabets, and when the drive units are referred to as a whole, reference number 21 is used) are supplied from a maker (source) of the drive unit 21, they are set in (connected to) an arbitrary number of host units [11A], [11B], . . . [11-N] (for facilitating the description, the individual host units will be thus discriminated by alphabets, and when the host units are referred to as a whole, reference number 11 is used) at a host maker, i.e., a player maker, whereby respective keys [K-device] are supplied from the external device (PC) as shown in FIG. 1.

The respective keys [K-device] are held in, for example, a key information file [K-file] stored in a (external) PC used in the manufacturing (assembling) line (assembling maker) of the host unit 11. When an arbitrary drive unit 21 is set in a host unit 11, a corresponding key [K-device] is supplied to the host unit 11, and also to the drive unit 21 via the host unit 11 at respective preset times.

The key [K-device] supplied from the key information file [K-file] to the host unit 11 and to the drive unit 21 via the host unit 11 is encrypted\decrypted using a unique secret key (MyK-drive) belonging to the maker of the drive unit 21 or to the maker of an encryption LSI used for drive units, and also using a unique secret key (MyK-host) belonging to the maker of the host unit 11 or to the maker of an encryption LSI used for host units, respectively.

Namely, the key [K-device] used for interactive authentication between the drive unit and host unit is encrypted using a unique secret key (MyK-drive) belonging to the maker of the drive unit 21 or to the maker of an encryption LSI used for drive units, and also using a unique secret key (MyK-host) belonging to the maker of the host unit 11 or to the maker of an encryption LSI used for host units, respectively. The thus-encrypted keys are stored in the NVMs 15 and 25 of the units 11 and 21, and are read therefrom and decrypted by the unique keys (MyK-drive) and (MyK-host), respectively.

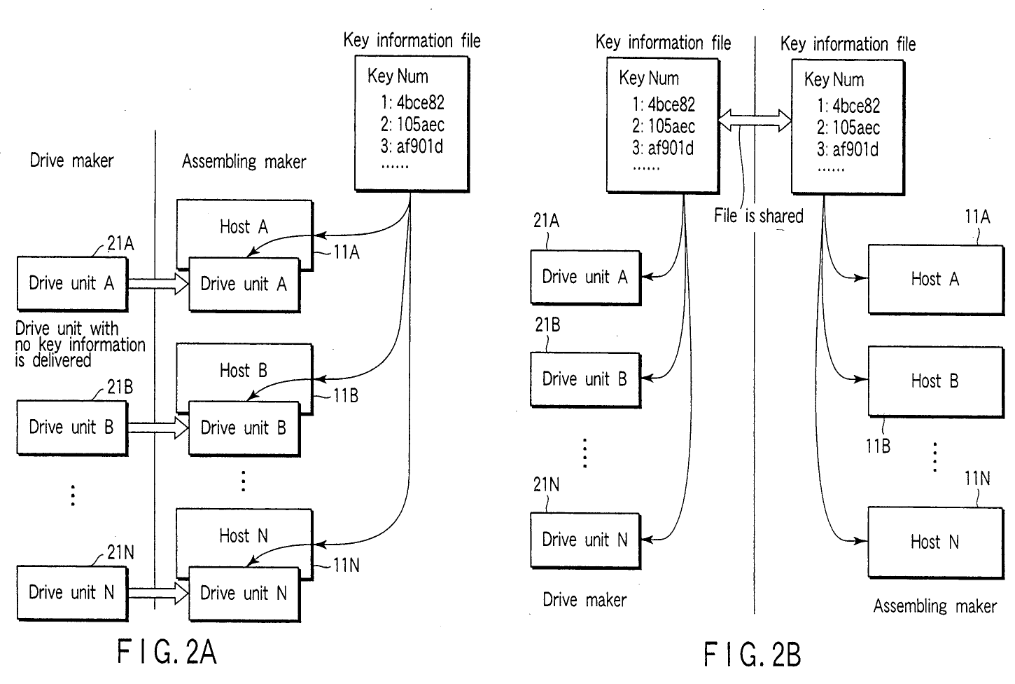

The drive-unit manufacturer, host-unit manufacturer and assembling maker (player manufacturer) can independently design and produce drive units, host units and players. Further, even if, for example, the assembling maker is identical to the host-unit manufacturer, or even if the assembling maker is identical to the drive-unit manufacturer, the manner of handling of each key [K-device] supplied from the key information file [K-file] shown in FIG. 2A is substantially the same, and no problem will be raised from uniform management by the host-unit manufacturer or assembling maker.

Furthermore, the key [K-device] has different values between different sets (players). Therefore, when, for example, data used in a player, namely, content held in a DVD disk set for playing, is transferred from the DVD disk to the hard disk device (HDD) 21, or when content temporarily stored in the HDD 21 is copied therefrom to the DVD disk, it is encrypted using the key [K-device] that has different values in different sets (players). Accordingly, the security of data (content) when it is copied or moved is enhanced.

Since, in this method, key information [K-device] is written after the drive unit is connected to the host unit, it is not necessary to prepare a file for managing the correspondence in secret key information between the host unit and drive unit. Further, even if, for example, a drive unit incorporated in a assembled player must be exchanged for another, encrypted key data can be shared between the drive unit and host unit simply by writing another key data item to them.

In addition, in the above method, no key information [K-device] is written in the drive unit before it is incorporated in a player. Even after the drive unit is incorporated in a player, the key information [K-device] is held in a nonvolatile memory connected to the encryption section, and therefore cannot easily be read from the outside.

Note that it is not necessary to manage written secret information, and hence no problem will rise even if a value generated by a random number generator is directly written as secret information.

In contrast, in the case shown in FIG. 2B where the manufacturer of the drive unit 21 and that of the host unit 11 independently manage shared key information [K-device] (assuming that the key information file [K-file] is shared therebetween), it is necessary for the host-unit manufacturer or assembling maker to always manage the IDs of all drive and host units, their combinations, etc. This makes it difficult for, for example, the host-unit manufacturer or assembling maker to set a drive unit in an arbitrary host unit. If, for instance, a certain drive unit is malfunctioned, the corresponding host unit cannot be set until another suitable drive unit is produced.

Further, whenever a failure in manufacture occurs in which authentication after a drive unit is set in a host unit has failed and key information [K-device] assignment must be changed, it is necessary to, for example, assign new key information [K-device] (to manage new IDs of host and drive units and their combinations).

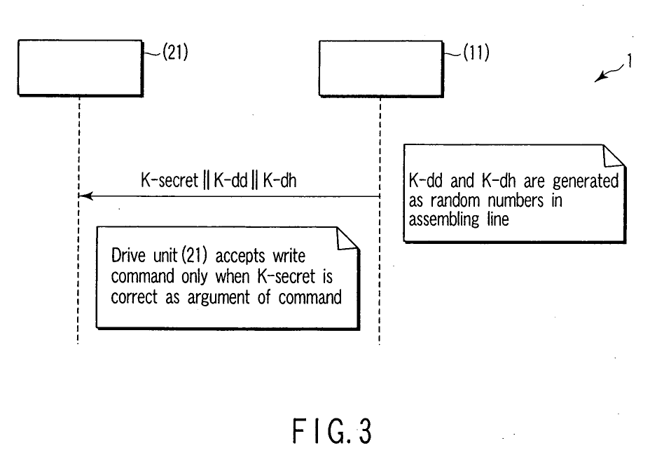

FIG. 3 is a view useful in explaining another routine of supplying the key information [K-device] when a host-unit or player (assembling) maker sets, into an arbitrary number of host units, an arbitrary number of drive units produced by a drive-unit maker as shown in FIG. 2A.

It is preferable that an encrypted key for reading data (content) be used as a session key generated when authentication between the drive unit 21 and host unit 11 has succeeded, and secret information (key data) [K-dd] and [K-dh] written as unique information to a set (player denoted by reference number 1 in FIG. 1) be used as shared secret value necessary for authentication, as is shown in FIG. 3.

Specifically, for instance, a secret value [K-secret] is beforehand buried in the firmware of the drive unit 21. Secret key data [K-share] is input to a parameter included in a write command output from the host unit 11 to copy therefrom shared encrypted key data [K-dd] and [K-dh] to the drive unit 21.

The drive unit 21, in turn, checks the parameter of the write command, and writes the shared encrypted key data [K-dd] and [K-dh] only when secret key data [K-share] is identical to the secret value [K-secret]. Thus, the secret value [K-secret] is a single value shared between all drive units 21 of the same model, while the shared encrypted key data [K-dd] and [K-dh] has different values between different drive units 21.

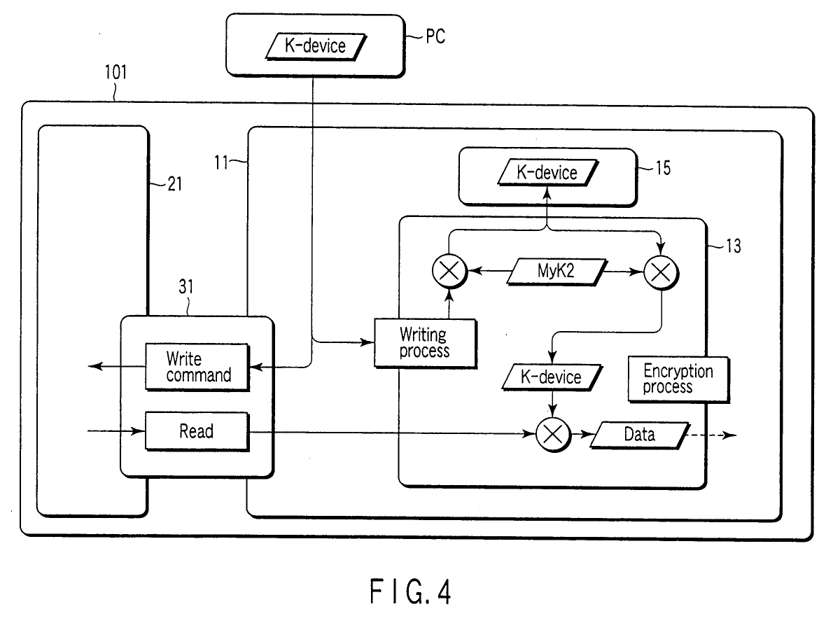

FIG. 4 shows an example of a flow of copying shared encrypted key data from the host unit to the drive unit, which flow example is used in the supply routine of the key [K-device] described with reference to FIGS. 1, 2A and 3. In a player 101 shown in FIG. 4, a host unit 11, encryption section 13 (included in the host unit 11), drive unit 21 and ATAPI bus 31, etc. have similar structures to those of the player (set) 1 of FIG. 1, and no detailed description is given thereof.

In the player 101 of FIG. 4, a shared encrypted key [K-device] specified by an external PC (key supply source) using pre-generated random numbers is written to the host unit 11 and drive unit 21 at preset times.

In the player of FIG. 4, the key-writing process is started at a point in time, at which the external PC (key supply source), for example, which holds a shared encrypted key [K-device] and is recognized as hardware, is connected to the player independently of the connection of the drive unit 21 to the player 101.

Specifically, when respective drive units 21 are connected to an arbitrary number of host units 11, or a drive unit is connected to at least one of the host units 11, and a PC holding the key information file [K-file] shown in FIG. 2A is connected to the encryption section 13 of the host unit 11 at a preset time, an arbitrary shared encrypted key [K-device] included in the key information file [K-file] is supplied from the PC to the host unit 11, and is simultaneously supplied to the encryption section 23 of the set drive 21 via the ATAPI bus 31.

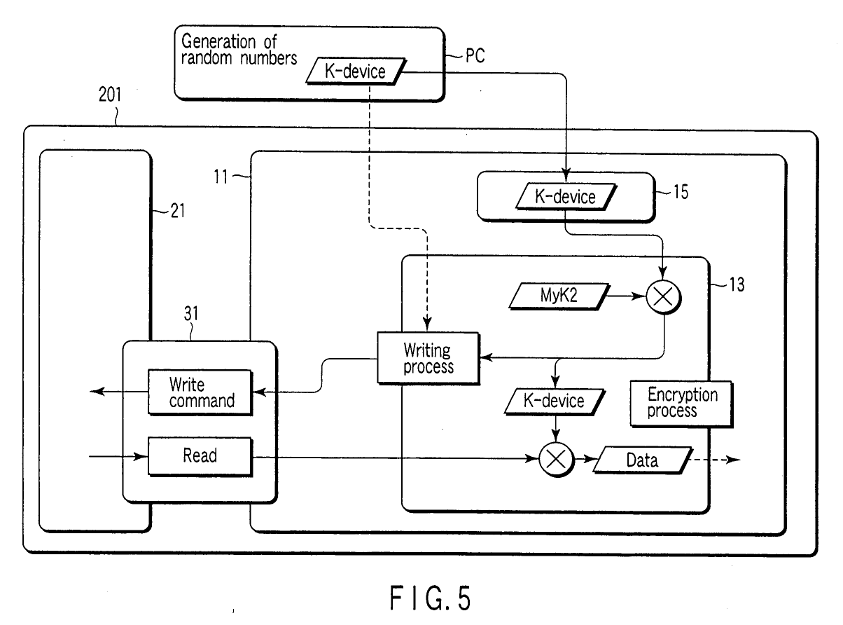

FIG. 5 shows another example of the flow of copying shared encrypted key data from the host unit to the drive unit, which flow example is used in the supply routine of the key [K-device] described with reference to FIGS. 1, 2A and 3. In a player 201 shown in FIG. 5, a host unit 11, encryption section 13 (included in the host unit 11), drive unit 21 and ATAPI bus 31, etc. have similar structures to those of the player (set) 1 of FIG. 1, and no detailed description is given thereof.

In the player 201 of FIG. 5, a shared encrypted key [K-device], which is shared between the host unit 11 and disk unit 21 that are beforehand subjected to random number processing, is written by an external PC (key supply source) only to the host unit 11 at a preset time.

In the player of FIG. 5, the key-writing process is started at a point in time, at which the external PC (key supply source), for example, which holds a shared encrypted key [K-device] and is recognized as hardware, is connected to the player independently of the connection of the drive unit 21 to the player 201.

Specifically, when respective drive units 21 are connected to an arbitrary number of host units 11, or a drive unit is connected to at least one of the host units 11, and a PC holding the key information file [K-file] shown in FIG. 2A is connected to the encryption section 13 of the host unit 11 at a preset time, an arbitrary shared encrypted key [K-device] included in the key information file [K-file] is supplied from the PC to the host unit 11, and is then supplied therefrom to the encryption section 23 of the set drive 21 via the ATAPI bus 31.

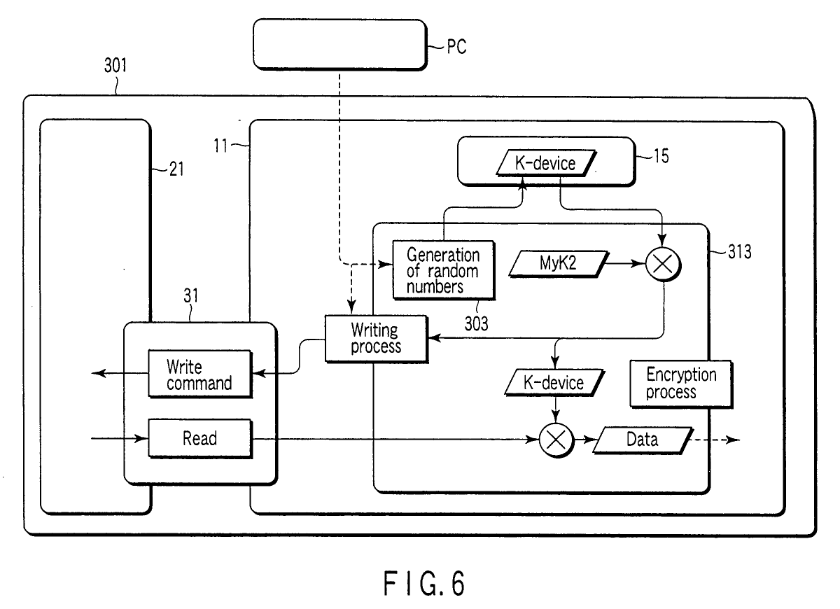

FIG. 6 shows yet another example of the flow of copying shared encrypted key data from the host unit to the drive unit, which flow example is used in the supply routine of the key [K-device] described with reference to FIGS. 1, 2A and 3. In a player 301 shown in FIG. 6, a host unit 11, drive unit 21, encryption section 23 (included in a drive unit 21) and ATAPI bus 31, etc. have similar structures to those of the player (set) 1 of FIG. 1, and no detailed description is given thereof.

In the player 301 of FIG. 6, a random-number generator 303 for generating an encrypted key [K-device] shared between the host unit 11 and disk unit 21 is provided in an encryption section 313 incorporated in the host unit 11. An external PC is used only for the generation of the key [K-device] in the host unit 11.

In the player of FIG. 6, the key-writing process is started at a point in time, at which the external PC (key supply source), for example, which holds a shared encrypted key [K-device] and is recognized as hardware, is connected to the player independently of the connection of the drive unit 21 to the player 301.

In the same manner as in the case of FIG. 5, the key [K-device] read from the host unit 11 is transferred to the encryption section 23 of the drive unit 21 via the ATAPI bus 31.

In the above-described embodiments, the host unit in which the drive unit is set is a DVD (disk) player. However, it is a matter of course that the host unit may be an HD DVD player that can read content from a high-definition DVD (HD DVD) disk of a higher recording density, or be a recorder that can record content input from the outside.

Further, although, in the players employed in the embodiments, the encryption sections have mainly been described, the players may naturally incorporate, as well as the drive unit, a data processing unit that can read data (content) from a semiconductor memory represented by, for example, a memory card, or various interfaces for receiving data (content) from an external player/recorder/camera, etc., which having the same function as the data processing unit.

Furthermore, the players naturally include an output section for displaying, on a display unit, data (content) read by the drive unit, or a data processing section for transferring data to another recording device.

Also, the encryption sections for processing the key [K-device] may be formed of an integrated circuit structure, as well as the structures shown in FIGS. 1, 4 and 6.

As described above, one of the embodiments of the invention is directed to a DVD player or recorder that includes a host unit for reading or writing information from or to a disk drive unit via a versatile interface, and is characterized by comprising data processing means, writing control means and setting means. The data processing means is used to acquire shared encrypted key data, or original data from which the shared encrypted key data can be calculated. The shared encrypted key data is used to encrypt data transferred between the two units (drive unit and host unit) in the player. The writing control means is used to issue an instruction to write the shared encrypted key data or original data. The setting means is used to set a shared key used to write the shared encrypted key data or original data.

Another embodiment of the invention is directed to writing control means for issuing, from a host unit to a DVD drive unit, an instruction to write shared encrypted key data, or original data from which the shared encrypted key data can be calculated, and is characterized in that only when a parameter included in the instruction received by the DVD unit is identical to a value preset between the DVD drive unit and host unit, writing is permitted. This makes it difficult to write the shared encrypted key data or original data even if a versatile ATAPI bus is used in the player.

Still another embodiment of the invention is characterized in that data generating means for generating shared encrypted key data, or original data from which the shared encrypted key data can be calculated is provided (written) by, for example, an external PC (personal computer) used during a manufacturing process after a drive unit and host unit are connected to each other.

A further embodiment of the invention is characterized in that data generating means for generating shared encrypted key data, or original data from which the shared encrypted key data can be calculated is provided (written) by means incorporated in a host unit.

Another embodiment of the invention is directed to a DVD drive unit to be connected to, for example, a host unit via a versatile interface, and is characterized by comprising nonvolatile memory means, and writing control means for writing, to the nonvolatile memory means, key data to be supplied to the drive unit via an interface, and characterized in that the data written to the nonvolatile memory means cannot be read only using the interface.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information playback apparatus comprising:
a disk drive unit configured to read information from a disk-shaped recording medium;
an information playback main unit holding the disk drive unit and configured to supply a display unit with an output of the disk drive unit in a state in which the output is permitted to be displayed on the display unit; and
an interface holding shared key information shared between the disk drive unit and the information playback main unit, the interface being configured at least to supply the shared key information to the information playback main unit, and to transfer the shared key information from the information playback main unit to the disk drive unit.

2. The information playback apparatus according to claim 1, wherein the shared key information is written to the disk drive unit via the interface after the disk drive unit is connected to the information playback main unit.

3. The information playback apparatus according to claim 1, further comprising shared-key setting means for setting a shared key used to write, to the disk drive unit, original data from which the shared encrypted key data is configured to be calculated, after the disk drive unit is connected to the information playback main unit.

4. The information playback apparatus according to claim 3, wherein when the disk drive unit receives an instruction to write the original data, the shared-key setting means permits the disk drive unit to write the original data only when a parameter included in the instruction is identical to a value preset between the disk drive unit and the information playback main unit.

5. The information playback apparatus according to claim 4, wherein when an external key supply source which supplies the shared key used to write the original data is connected after the disk drive unit is connected to the information playback main unit, the shared-key setting means acquires the original data from the external key supply source.

6. The information playback apparatus according to claim 4, wherein the shared-key setting means is included in the information playback main unit.

7. An information playback apparatus comprising:
a disk drive unit configured to read information from a disk-shaped recording medium;
an information playback main unit holding the disk drive unit and configured to supply a display unit with an output of the disk drive unit in a state in which the output is permitted to be displayed on the display unit;
an interface holding shared key information shared between the disk drive unit and the information playback main unit, the interface being configured at least to supply the shared key information to the information-reading main unit, and to transfer the shared key information from the information playback main unit to the disk drive unit; and
a memory unit provided in the information playback main unit, inhibited from being directly accessed by the interface, the memory unit holding key information shared between the disk drive unit and the information playback main unit.

8. The information playback apparatus according to claim 7, wherein:
shared encrypted key data, or original data from which the shared encrypted key data is configured to be calculated, is written only when a supply source which supplies a shared key used to write the original data is connected, or the shared encrypted key data or the original data is supplied from an external device, after a disk drive unit is connected to an information playback main unit; and
the writing the shared encrypted key data is permitted, only when the disk drive unit has received an instruction to write the shared encrypted key data, and a parameter included in the instruction is identical to a value preset between the disk drive unit and the information playback main unit.

9. An information playback method comprising:
writing shared encrypted key data, or original data from which the shared encrypted key data is configured to be calculated, only when a supply source which supplies a shared key used to write the original data is connected, or the shared encrypted key data or the original data is supplied from an external device, after a disk drive unit is connected to an information playback main unit,
wherein the writing the shared encrypted key data is permitted, only when the disk drive unit has received an instruction to write the shared encrypted key data, and a parameter included in the instruction is identical to a value preset between the disk drive unit and the information playback main unit.
